(19) United States
(12) Patent Application Publication
(10) Pub. No.: US 2025/0383924 A1
(43) Pub. Date: Dec. 18, 2025

(54) NAMESPACE RESOURCE CONSUMPTION PREDICTION BY MULTIVARIATE TIMESERIES FORECASTING WITH GRAPH NEURAL NETWORK

(71) Applicant: Dell Products L.P., Round Rock, TX (US)

(72) Inventors: Jason Liu, Wellesley, MA (US); Vinay Sawal, Fremont, CA (US); Fatemeh Azmandian, Raynham, MA (US)

(21) Appl. No.: 18/747,155

(22) Filed: Jun. 18, 2024

(51) Int. Cl. G06F 9/50

(52) U.S. Cl. CPC G06F 9/5027

(57) ABSTRACT

The technology described herein is directed towards determining predicted and/or actual namespace resource consumption in an automated system for deployment, scaling, and management of containerized applications, such as in a Kubernetes® system. Given time series data representative of cluster-level resource consumption history at a percentage scale, resource consumption history for every namespace in the cluster at an absolute scale, and resource consumption history for each individual pod in the cluster at an absolute scale, multivariate time series forecasting with graph neural networks learns the hidden (dynamic and time variant) variable dependencies during a forecasting process that includes graph convolution followed by temporal convolution. The result is a forecast of a namespace's resource consumption.

### BACKGROUND

In an automated system for deployment, scaling, and management of containerized applications, such as the open source container orchestration system known as Kubernetes®, applications can be structured as containers that run services and the like. Multiple containers can run in a pod, which in turn can run on a node of a multi-node cluster. A namespace is a logical construct, such as associated with a particular enterprise group, that can span multiple nodes in the cluster; a namespace corresponds to a virtual level between the cluster and nodes. There can be many different per-cluster namespaces among the nodes of a cluster that run applications and services via the pods/containers.

### BRIEF DESCRIPTION OF THE DRAWINGS

The technology described herein is illustrated by way of example and not limited in the accompanying figures in which like reference numerals indicate similar elements and in which:

FIG. 1 is a block diagram representation of an example system in which a multivariate timeseries forecasting component predicts resource consumption for a namespace, in accordance with various implementations and embodiments of the subject disclosure.

FIG. 2 is a graphical representation of example timeseries data representative of pod resource consumption history for CPU usage for a number of containers, in accordance with various implementations and embodiments of the subject disclosure.

FIG. 3 is a graphical representation of example timeseries data representative of CPU usage by namespace, in accordance with various implementations and embodiments of the subject disclosure.

FIG. 4 is a graphical representation of example timeseries data representative of namespace resource consumption for normalizing from an absolute scale to a percentage scale, in accordance with various implementations and embodiments of the subject disclosure.

FIG. 5 is a block diagram representation of an example system showing additional details of the multivariate timeseries forecasting component, in accordance with various implementations and embodiments of the subject disclosure.

FIG. 6 is a graphical representation of example timeseries data representative of predicted and actual CPU usage by namespace, in accordance with various implementations and embodiments of the subject disclosure.

FIG. 7 is a flow diagram showing example operations related to performing multivariate time series forecasting based on the time series datasets, in accordance with various implementations and embodiments of the subject disclosure.

FIG. 8 is a flow diagram showing example operations related to obtaining namespace-level forecast data usable to predict namespace resource consumption, in accordance with various implementations and embodiments of the subject disclosure.

FIG. 9 is a flow diagram showing example operations related to forecasting future per-namespace resource usage in a service container orchestration system, in accordance with various implementations and embodiments of the subject disclosure.

FIG. 10 is a block diagram representing an example computing environment into which the subject matter described herein may be incorporated and/or may communicate.

FIG. 11 depicts an example schematic block diagram of a computing environment with which the disclosed subject matter can interact/be implemented at least in part, in accordance with various implementations and embodiments of the subject disclosure.

### DETAILED DESCRIPTION

Various implementations and embodiments of the technology described herein are generally directed towards resource consumption prediction at the namespace level by using multivariate time series forecasting with a graph neural network. As one example, Kubernetes® (K8s) is one suitable platform for supporting scalable cloud platforms, in which there are many design guidelines for how applications can be structured as containers and run.

In general, there are various machine learning modeling techniques that can be applied to forecast needed resources at the node level and at the cluster level, based on historical data with relative percentages to total available resources. At the same time, the applications/container services are usually managed through logically isolated “namespace” levels (between the node level and the cluster level), and there are tools to monitor how many resources (e.g., CPU/memory/disk) are used by a specific namespace. However, there are no previously known tools to apply machine learning forecasting models for the namespace level to be at a consistent percentage scale like node-level and cluster-level forecasting can do, primarily because the total available resources are not a constant value (under high availability operations where some portion of the cluster may not be available). If machine learning forecasting is performed from such historical data without the resource limitation, the model may predict resource usage to go over the limitation, whereby the results will be significantly wrong, because resource consumption will stay at one-hundred percent, and compensate by expanding time (i.e. delaying the execution) in modern systems.

Described herein is multivariate time series forecasting with a graph neural network that, based on available timeseries datasets, models the hidden spatial and/or temporal relationships between the variables used at the namespace level. As will be understood, the technology described herein is able to apply a machine learning model that can learn the hidden (dynamic and time variant) dependencies as part of the forecasting process, and thereby generate an accurate namespace resource consumption prediction.

Reference throughout this specification to “one embodiment,” “an embodiment,” “one implementation,” “an implementation,” etc. means that a particular feature, structure, or characteristic described in connection with the embodiment/implementation is included in at least one embodiment/implementation. Thus, the appearances of such a phrase “in one embodiment,” “in an implementation,” etc. in various places throughout this specification are not necessarily all referring to the same embodiment/implementation. Furthermore, the particular features, structures, or characteristics may be combined in any suitable manner in one or more embodiments/implementations. It also should be noted that terms used herein, such as “optimization,” “optimize” or “optimal” and the like (e.g., “maximize,” “minimize” and so on) only represent objectives to move towards a more optimal state, rather than necessarily obtaining ideal results.

It should be understood that any of the examples and/or descriptions herein are non-limiting. As one example, Kubernetes® is described as one suitable automated system for deployment, scaling, and management of containerized applications; notwithstanding, the technology described herein is not limited to Kubernetes® systems. Thus, any of the embodiments, example embodiments, concepts, structures, functionalities or examples described herein are non-limiting, and the technology may be used in various ways that provide benefits and advantages in computing and forecasting resource usage in general.

The subject disclosure will now be described more fully hereinafter with reference to the accompanying drawings in which example components, graphs and/or operations are shown. In the following description, for purposes of explanation, numerous specific details are set forth in order to provide a thorough understanding of the various embodiments. However, the subject disclosure may be embodied in many different forms and should not be construed as limited to the examples set forth herein.

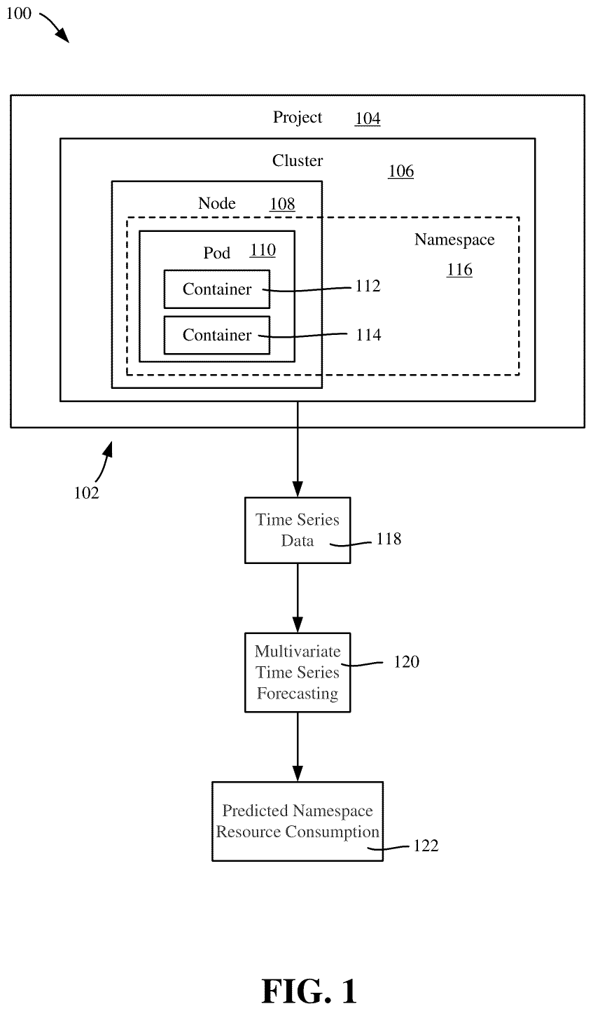

FIG. 1 shows an example system/architecture 100 that includes a container management system 102 for deployment, scaling, and management of containerized applications, in which a project 104 is executed by a node cluster 106 that includes a group of nodes. One such node 108 is shown in FIG. 1, along with an example pod 110 in which service containers 112 and 114 are executed. Typically for management purposes, a distinctly-named (per cluster) logical/virtual namespace 116 (a software construct) is used for isolating groups of resources within a single cluster.

As set forth herein, the namespace can span multiple nodes, and thus there can be many pods and containers that are being executed within a namespace construct. As such, there is no straightforward way to determine/monitor the resource usage for a given namespace, as multiple different namespaces can be simultaneously using the same nodes, and therefore resources of the cluster.

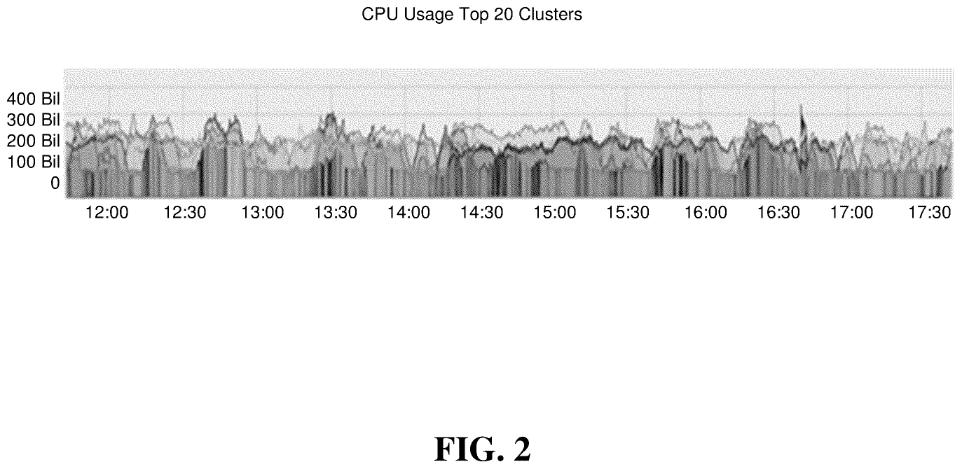

By way of example, consider that one namespace is consuming most of the cluster resources, causing performance problems, but the cluster is running multiple namespaces. Determining which namespace is the one that needs to be dealt with (e.g., reassigned to a more powerful cluster and/or a cluster that has less concurrently-executing namespaces) is thus not directly determinable. However, system metrics do have the data at the pod level for each individual service. For example, FIG. 2 shows the example execution history data for the top twenty pods in a cluster captured over time. The measurement used in the example is the CPU usage per core at nanoseconds, measured with an absolute value scale, which avoids the problem of knowing the total amount of available resources. Other resources such as networking-related resources can also be measured.

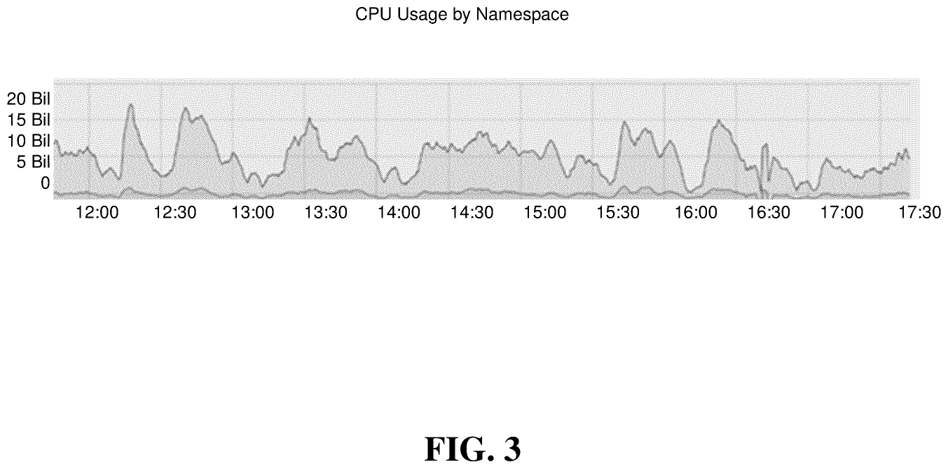

Further, there are mechanisms to monitor how many resources (like CPU/memory/storage device (disk)) are used by specific namespace as shown in FIG. 3. Note however that the namespace resource usage is shown at an absolute scale, not as a percentage of total resources.

Described herein is resolving the problem of obtaining a forecast of resource consumption at the namespace level, and relative percentage to the total available resources. The solution described herein is based on available measurement information (timeseries data 118, FIG. 1), namely cluster-level resource consumption history at a percentage scale, resource consumption history for every namespace in the cluster at an absolute scale, and resource consumption history for each individual pod in the cluster at an absolute scale. As described herein, multivariate time series forecasting 120 based on the timeseries data 118 is able to generated predicted per-namespace resource consumption data, as represented in FIG. 1 by block 122.

It should be noted that one naïve solution is to aggregate (sum) namespace-level resource usage to cluster-level resource consumption, in which the aggregation needs to be correlated with cluster level resource consumption (except at different scales, namely absolute versus percentage). The correlation can be applied to infer a namespace-level forecast from the cluster-level forecast, e.g., a constant ratio of 35% of the cluster-level resources for namespace A, 25% for namespace B, and 40% for namespace C. If this was feasible, models such as temporal matrix factorization could be used to decompose the forecast into two matrices.

However, in reality there are hidden dependencies among the namespace variables, in that the pod execution is not really isolated from each other, but instead follows business logic with shared resource constraints. Thus, the dependency among pods, which are not isolated with respect to individual execution in business logic, is not known. Shared resources can be another kind of hidden dependency. This hidden dependency prevents the above decomposition approach to get the namespace level resource consumption forecast.

Alternatively, a bottom-up approach can be attempted using machine learning to automatically learn the dependency during the process. More particularly, if pod-level resource usage can be aggregated (summed) to namespace-level resource consumption, the aggregation should be correlated with namespace-level resource consumption (at the same absolute scale), provided the dependency among PODS can be learned during this process. Similarly, if namespace level resource consumption can be aggregated (summed) to the cluster level, the aggregation should be correlated with cluster-level resource consumption (at different scales: absolute versus percentage), provided the dependency among namespaces-to-cluster interactions can be learned.

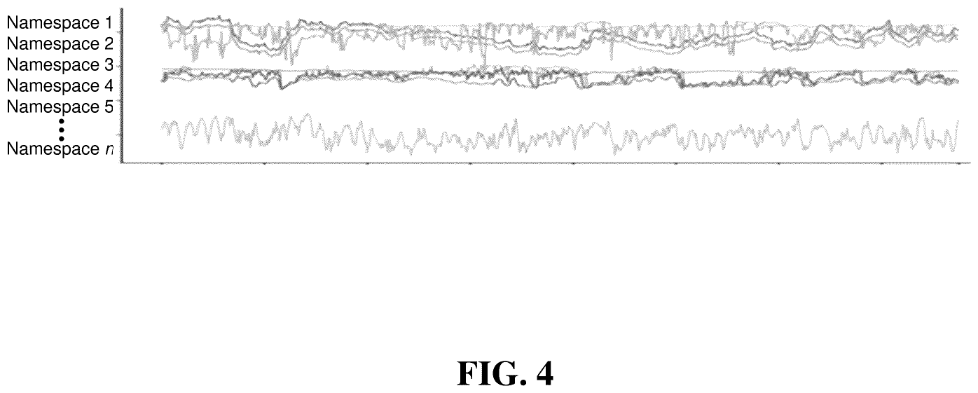

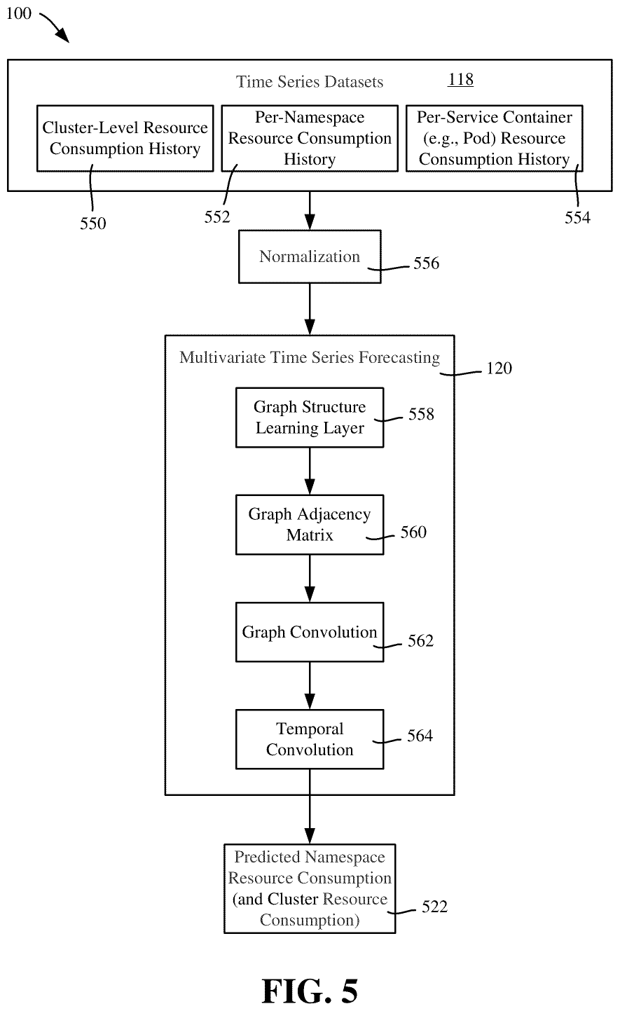

Thus, described herein is applying a machine learning model that can learn the hidden (dynamic and time variant) dependency as part of a forecasting process. A challenge is learning the dependency among multivariable data. To this end, a model based on multivariate time series forecasting with graph neural networks is employed. The input to the model includes multiple time series datasets 118 (FIGS. 1 and 5), where each dataset is for a variable. This includes cluster-level historical resource consumption history 550 (at percentage scale), a list of the namespace-level resource consumption history 552 (absolute scale) as in FIGS. 3 and 4, and each pod's resource consumption history 554 (absolute scale) as in FIG. 2.

Prior to using the model, feature preparation is performed to normalize (block 556 of FIG. 5) the namespace resource consumption history to be percentage level. A suitable formula is:

$$Namespace i resource consumption , at time t at percentage scale = \frac{at time t , namespace i resource consumption}{at time t , sum of all namespace resource consumption}$$

Note that this is different than input one cluster-level resource consumption at percentage scale, which is divided by total available resources. The final adjustment is performed after the forecast.

To convert the namespace level resource consumption forecast to the correct scale (for CPU/memory/disk usage), the following formula can be used:

$$namespace i resource consumption forecast at time t at percentage scale ( which is divided by sum of all name space resource consumption forecast ) \times at time t , cluster - level resource consumption at percentage scale ( which is divided by the total available resources ) = \frac{At time t , namespace i resource consumption forecast}{\begin{matrix}At time t , sum of all namespace resource consumption forecast \\ at time t , cluster - level resource consumption at percentage scale \\ ( which is divided by the total available resources ) .\end{matrix}} \times$$

Turning to the multivariate timeseries forecasting procedure (block 120 of FIG. 5), the procedure learns the relationships among the variables. A graph learning layer 558 (graph neural network) adaptively learns a graph adjacency matrix 558 (representative of a graph structure) to capture the hidden relationships among the time series data, using a sampling approach, e.g., one that only calculates pair-wise relationships among a subset of nodes. The procedure applies graph convolution 562 to establish a model to fuse a node's information with its neighbor nodes' information to handle dependencies in the graph. In one implementation, the graph convolution module includes two mix-hop propagation layers to process inflow and outflow information passed through each node separately.

Temporal convolution 564 is next applied, e.g., with a set of standard dilated one-dimensional convolution filters to extract high-level temporal features. The procedure then generates a forecast 522 for the target time at the namespace level (absolute scale) and cluster-level forecasting (percentage scale).

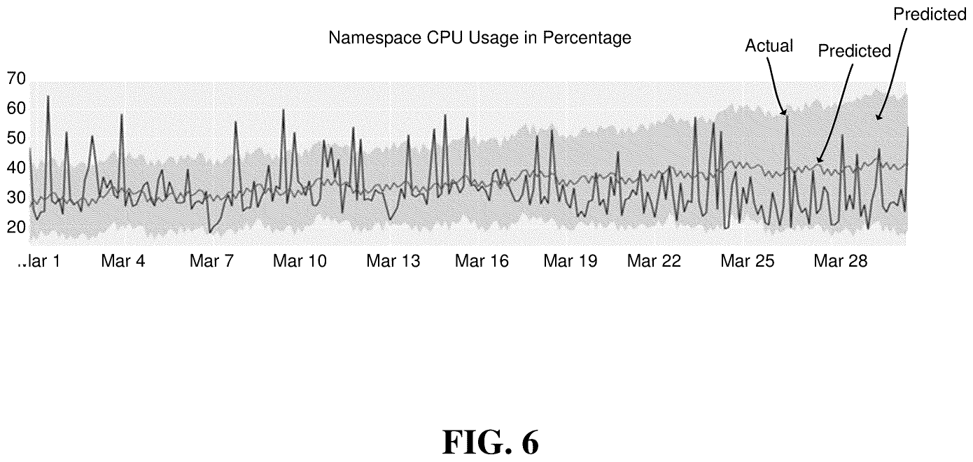

FIG. 6 shows an example of predicted versus actual CPU usage data over a number of days for a namespace. The graph is in a percentage scale based on the above-described conversion formula.

Variables and related information are part of the results of the dependency graph, based on using machine learning to learn the dependency. There are business values in recognizing such variables, so that human engineers can attach them to meanings. For example, the results can be used to resolve questions such as whether it a heavy workload time for the US East Coast, whether it a Black Friday shopping peak time, whether it a Christmas holiday weekend, whether there any emergency/crisis events occurring, and so forth. With such variables attached with meanings, they can be used for resource planning, to schedule system maintenance, to arrange/prepare support schedules, and so forth.

Indeed, the use of the association between the detected hidden variable to a human-recognizable terminology that is meaningful for an event/factor/process can be used for Kubernetes® namespace resource planning activities, such as buying extra CPU/GPU/storage devices, and/or performing system maintenance/upgrades. One use case example includes, for a namespace 1 used by a billing/payment system, an example of the hidden variable is the invoice due date. From a timeseries graph this can be detected, and human engineers can establish that this variable is related to the billing payment due date. As a more particular example, if an invoice is due the third day of every month, then the hidden variable can determine whether a certain day is the invoice due date. If so, the CPU/memory/disk usage of this namespace 1 for those billing/payment-related container services will be relatively higher around the first through the fourth days of the month, and therefore, it would be undesirable to schedule system changes during those days.

As another use case example, for a namespace 2 used by ordering, an example of the hidden variable can be the promotion/discount period of time. For example, if within a discount promotion period of time for some product X, the ordering-related containers for product X will be busy, such that system changes should not be scheduled during those days. With this kind of feature, which lets people attach meanings to those hidden variables detected in the dependency graph, users are enabled to name such meaningful variables for the system planning activities.

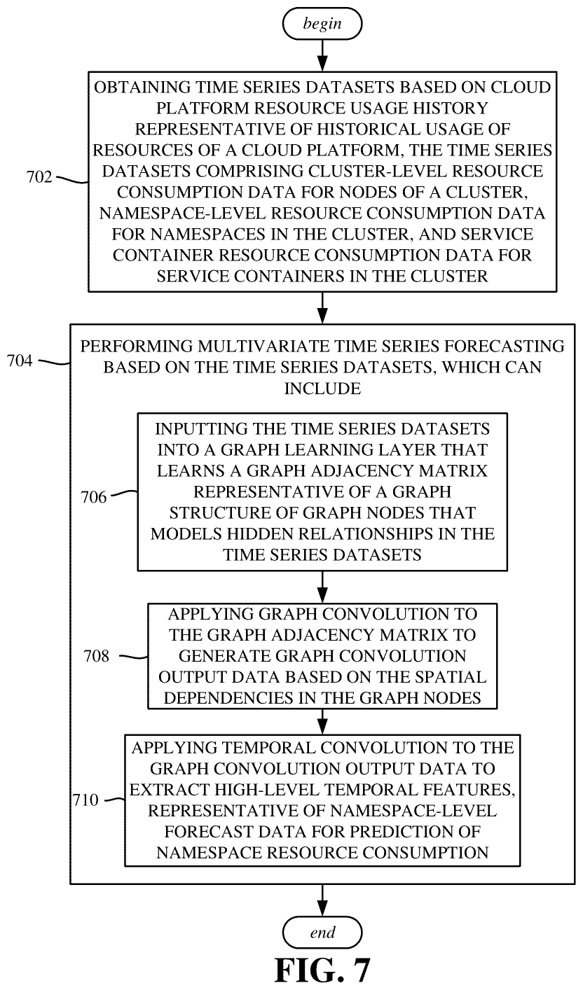

One or more implementations and embodiments can be embodied in a system, such as represented in the example operations of FIG. 7, and for example can include a memory that stores computer executable components and/or operations, and at least one processor that executes computer executable components and/or operations stored in the memory. Example operations can include operation 702, which represents obtaining timeseries datasets based on cloud platform resource usage history representative of historical usage of resources of a cloud platform, the timeseries datasets comprising cluster-level resource consumption data for nodes of a cluster, namespace-level resource consumption data for namespaces in the cluster, and service container resource consumption data for service containers in the cluster. Example operation 704 represents performing multivariate timeseries forecasting based on the timeseries datasets, which can include operations 706, 708 and 710. Example operation 706 represents inputting the timeseries datasets into a graph learning layer that learns a graph adjacency matrix representative of a graph structure of graph nodes that models hidden relationships in the timeseries datasets. Example operation 708 represents applying graph convolution to the graph adjacency matrix to generate graph convolution output data based on the spatial dependencies in the graph nodes. Example operation 710 represents applying temporal convolution to the graph convolution output data to extract high-level temporal features, representative of namespace-level forecast data for prediction of namespace resource consumption.

The namespace-level resource consumption data can be maintained in an absolute scale, and further operations can include normalizing the namespace resource consumption history to a percentage scale.

The service container resource consumption data can be maintained in an absolute scale, and further operations can include normalizing the service container resource consumption data to a percentage scale.

The service container resource consumption data can be further representative of service containers of one or more pods of a containerized application deployment, scaling, and management system.

The cluster-level resource consumption data can include at least one of: central processing unit (CPU) usage data representative of CPU usage by the cluster, memory usage data representative of memory usage by the cluster, or storage device usage data representative of storage device usage by the cluster.

The graph learning layer can include a graph neural network.

The graph learning layer can learn the graph adjacency matrix based on sampling operations. The sampling operations can determine pair-wise relationships among a subset of the graph nodes.

Applying the graph convolution can include using a graph convolution module that can include mix-hop propagation layers that process inflow and outflow information passed through each graph node separately.

The high-level temporal features can be further representative of cluster-level forecast data for prediction of cluster resource consumption. The namespace-level forecast data can be represented according to an absolute scale, and the cluster-level forecast data can be represented according to a percentage scale.

Applying the temporal convolution can include applying a set of one or more convolution filters.

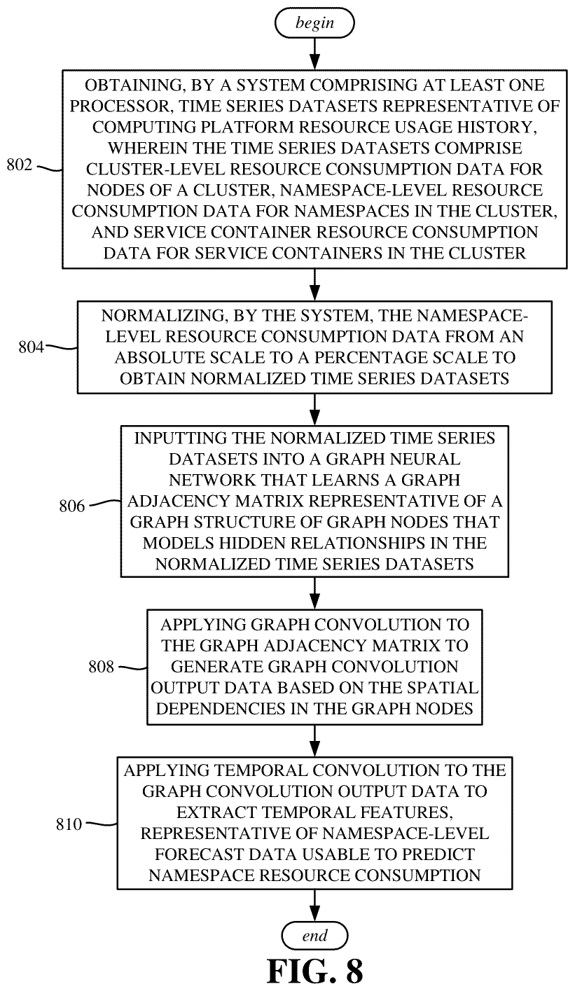

One or more example implementations and embodiments, such as corresponding to example operations of a method, are represented in FIG. 8. Example operation 802 represents obtaining, by a system comprising at least one processor, timeseries datasets representative of computing platform resource usage history, wherein the timeseries datasets can include cluster-level resource consumption data for nodes of a cluster, namespace-level resource consumption data for namespaces in the cluster, and service container resource consumption data for service containers in the cluster. Example operation 804 represents normalizing, by the system, the namespace-level resource consumption data from an absolute scale to a percentage scale to obtain normalized timeseries datasets. Example operation 806 represents inputting the normalized timeseries datasets into a graph neural network that learns a graph adjacency matrix representative of a graph structure of graph nodes that models hidden relationships in the normalized timeseries datasets. Example operation 808 represents applying graph convolution to the graph adjacency matrix to generate graph convolution output data based on the spatial dependencies in the graph nodes. Example operation 810 represents applying temporal convolution to the graph convolution output data to extract temporal features, representative of namespace-level forecast data usable to predict namespace resource consumption.

The graph neural network can learn the graph adjacency matrix based on sampling operations that determine pair-wise relationships among a subset of the graph nodes. Applying the temporal convolution further extracts the temporal features representative of cluster-level forecast data usable to predict cluster resource consumption.

Obtaining the timeseries datasets can include obtaining the service container resource consumption data for service containers of one or more pods of an automated system for deployment, scaling, and management of containerized applications.

The computing platform resource usage history can include at least one of: historical central processing unit (CPU) usage data, historical memory usage data, or historical storage device usage data.

Further operations can include facilitating, by the system based on the graph structure, an association between a detected hidden variable to human-recognizable terminology corresponding to at least one of: an event, factor, or process.

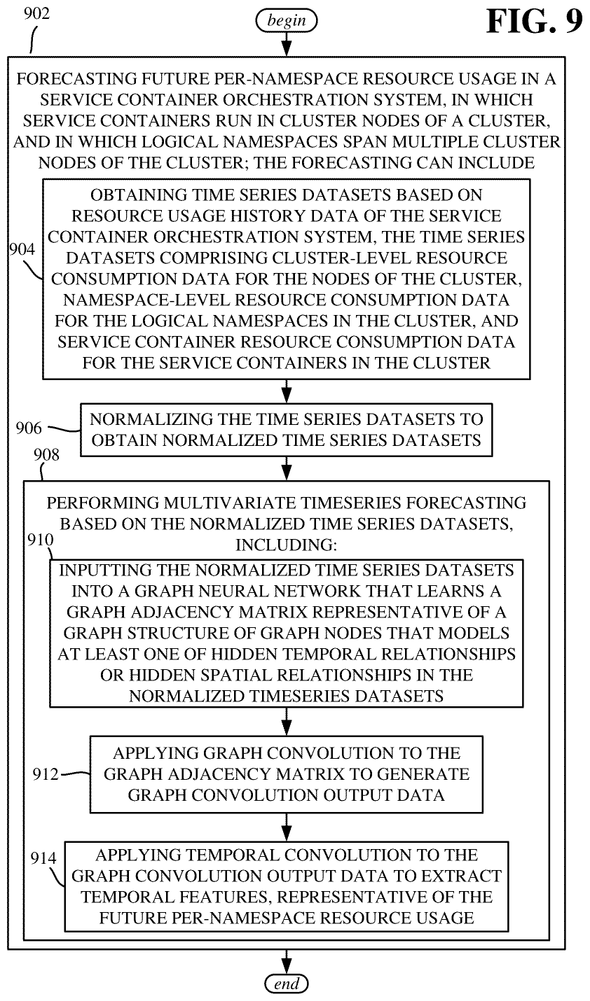

FIG. 9 summarizes various example operations, e.g., corresponding to a machine-readable medium, including executable instructions that, when executed by a processor, that, when executed by at least one processor, facilitate performance of operations. Example operation 902 represents forecasting future per-namespace resource usage in a service container orchestration system, in which service containers run in cluster nodes of a cluster, and in which logical namespaces span multiple cluster nodes of the cluster. The forecasting can include operations 904-914. Example operation 904 represents obtaining timeseries datasets based on resource usage history data of the service container orchestration system, the timeseries datasets comprising cluster-level resource consumption data for the nodes of the cluster, namespace-level resource consumption data for the logical namespaces in the cluster, and service container resource consumption data for the service containers in the cluster. Example operation 906 represents normalizing the timeseries datasets to obtain normalized timeseries datasets. Example operation 908 represents performing multivariate timeseries forecasting based on the normalized timeseries datasets, which can include operations 910, 912 and 914. Example operation 910 represents inputting the normalized timeseries datasets into a graph neural network that learns a graph adjacency matrix representative of a graph structure of graph nodes that models at least one of hidden temporal relationships or hidden spatial relationships in the normalized timeseries datasets. Example operation 912 represents applying graph convolution to the graph adjacency matrix to generate graph convolution output data. Example operation 914 represents applying temporal convolution to the graph convolution output data to extract temporal features, representative of the future per-namespace resource usage.

Applying the temporal convolution can further extract the temporal features representative of cluster-level forecast data for predicting future cluster resource consumption.

The service container orchestration system can include a Kubernetes® system in which the service containers are executed in one or more Kubernetes® pods.

As can be seen, the technology described herein resolves the problem in estimating a namespace-level resource consumption forecast, based on multivariate time series forecasting with graph neural network modeling techniques. The technology described herein overcomes the challenges due to the hidden dependencies among the variables (i.e., pods, namespace, and cluster) that otherwise introduce significant impacts. The graph neural network is applied to learn the graph of such dependency before processing temporal signals. Such a graph can also be shared with related experts to understand system behaviors.

The technology described herein thus helps to understand the resources needed for the application module living within its logical independent namespace. This is significant, because modern clouds rely on Kubernetes® to scale up properly, and resource preparation is a significant task in supporting the overall platform. The technology also can estimate the need for a “noisy neighbor” namespace that may overuse the shared resources and impact other application modules in the same cluster; a more complete picture can help in preparing a resource plan and budget.

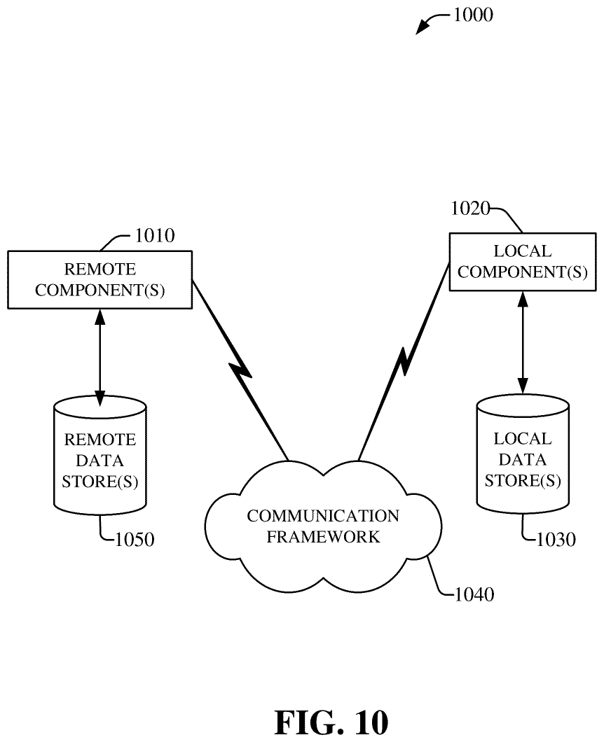

FIG. 10 is a schematic block diagram of a computing environment 1000 with which the disclosed subject matter can interact. The system 1000 can include one or more remote component(s) 1010. The remote component(s) 1010 can be hardware and/or software (e.g., threads, processes, computing devices). In some embodiments, remote component(s) 1010 can be a distributed computer system, connected to a local automatic scaling component and/or programs that use the resources of a distributed computer system, via communication framework 1040. Communication framework 1040 can comprise wired network devices, wireless network devices, mobile devices, wearable devices, radio access network devices, gateway devices, femtocell devices, servers, etc.

The system 1000 also comprises one or more local component(s) 1020. The local component(s) 1020 can be hardware and/or software (e.g., threads, processes, computing devices). In some embodiments, local component(s) 1020 can comprise an automatic scaling component and/or programs that communicate/use the remote resources 1010, etc., connected to a remotely located distributed computing system via communication framework 1040.

One possible communication between a remote component(s) 1010 and a local component(s) 1020 can be in the form of a data packet adapted to be transmitted between two or more computer processes. Another possible communication between a remote component(s) 1010 and a local component(s) 1020 can be in the form of circuit-switched data adapted to be transmitted between two or more computer processes in radio time slots. The system 1000 comprises a communication framework 1040 that can be employed to facilitate communications between the remote component(s) 1010 and the local component(s) 1020, and can comprise an air interface, e.g., Uu interface of a UMTS network, via a long-term evolution (LTE) network, etc. Remote component(s) 1010 can be operably connected to one or more remote data store(s) 1050, such as a hard drive, solid state drive, SIM card, device memory, etc., that can be employed to store information on the remote component(s) 1010 side of communication framework 1040. Similarly, local component(s) 1020 can be operably connected to one or more local data store(s) 1030, that can be employed to store information on the local component(s) 1020 side of communication framework 1040.

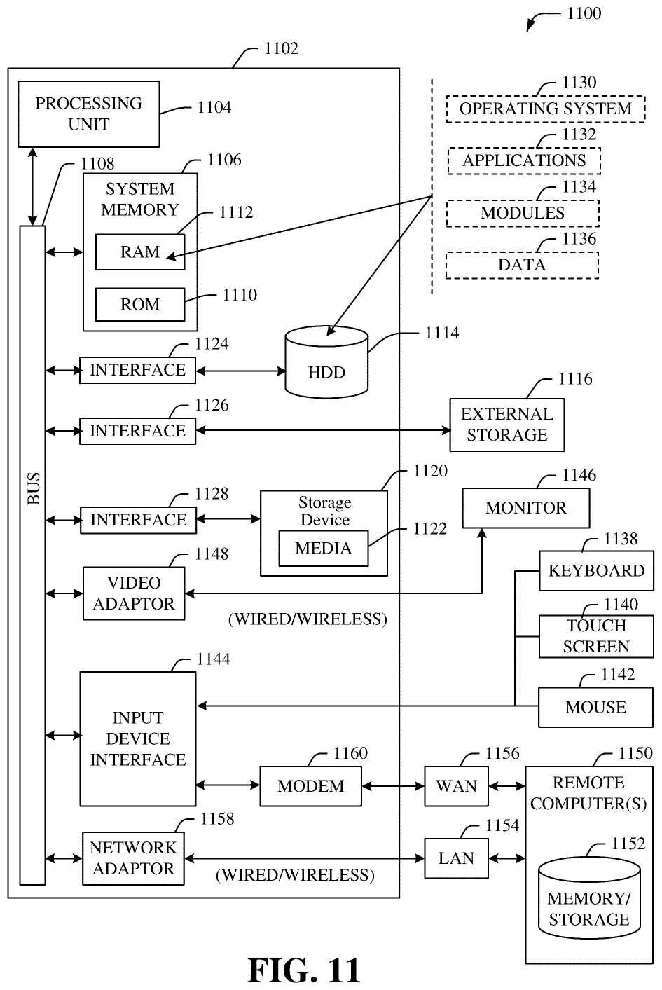

In order to provide additional context for various embodiments described herein, FIG. 11 and the following discussion are intended to provide a brief, general description of a suitable computing environment 1100 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 11, the example environment 1100 for implementing various implementations and embodiments described herein includes a computer 1102, the computer 1102 including a processing unit 1104, a system memory 1106 and a system bus 1108. The system bus 1108 couples system components including, but not limited to, the system memory 1106 to the processing unit 1104. The processing unit 1104 can be any of various commercially available processors. Dual microprocessors and other multi-processor architectures can also be employed as the processing unit 1104.

The system bus 1108 can be any of several types of bus structure that can further interconnect to a memory bus (with or without a memory controller), a peripheral bus, and a local bus using any of a variety of commercially available bus architectures. The system memory 1106 includes ROM 1110 and RAM 1112. A basic input/output system (BIOS) can be stored in a non-volatile memory such as ROM, erasable programmable read only memory (EPROM), EEPROM, which BIOS contains the basic routines that help to transfer information between elements within the computer 1102, such as during startup. The RAM 1112 can also include a high-speed RAM such as static RAM for caching data.

The computer 1102 further includes an internal hard disk drive (HDD) 1114 (e.g., EIDE, SATA), and can include one or more external storage devices 1116 (e.g., a magnetic floppy disk drive (FDD) 1116, a memory stick or flash drive reader, a memory card reader, etc.). While the internal HDD 1114 is illustrated as located within the computer 1102, the internal HDD 1114 can also be configured for external use in a suitable chassis (not shown). Additionally, while not shown in environment 1100, a solid state drive (SSD) could be used in addition to, or in place of, an HDD 1114.

Other internal or external storage can include at least one other storage device 1120 with storage media 1122 (e.g., a solid state storage device, a nonvolatile memory device, and/or an optical disk drive that can read or write from removable media such as a CD-ROM disc, a DVD, a BD, etc.). The external storage 1116 can be facilitated by a network virtual machine. The HDD 1114, external storage device(s) 1116 and storage device (e.g., drive) 1120 can be connected to the system bus 1108 by an HDD interface 1124, an external storage interface 1126 and a drive interface 1128, respectively.

The drives and their associated computer-readable storage media provide nonvolatile storage of data, data structures, computer-executable instructions, and so forth. For the computer 1102, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1112, including an operating system 1130, one or more application programs 1132, other program modules 1134 and program data 1136. All or portions of the operating system, applications, modules, and/or data can also be cached in the RAM 1112. The systems and methods described herein can be implemented utilizing various commercially available operating systems or combinations of operating systems.

Computer 1102 can optionally comprise emulation technologies. For example, a hypervisor (not shown) or other intermediary can emulate a hardware environment for operating system 1130, and the emulated hardware can optionally be different from the hardware illustrated in FIG. 11. In such an embodiment, operating system 1130 can comprise one virtual machine (VM) of multiple VMs hosted at computer 1102. Furthermore, operating system 1130 can provide runtime environments, such as the Java runtime environment or the .NET framework, for applications 1132. Runtime environments are consistent execution environments that allow applications 1132 to run on any operating system that includes the runtime environment. Similarly, operating system 1130 can support containers, and applications 1132 can be in the form of containers, which are lightweight, standalone, executable packages of software that include, e.g., code, runtime, system tools, system libraries and settings for an application.

Further, computer 1102 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1102, e.g., applied at the application execution level or at the operating system (OS) kernel level, thereby enabling security at any level of code execution.

A user can enter commands and information into the computer 1102 through one or more wired/wireless input devices, e.g., a keyboard 1138, a touch screen 1140, and a pointing device, such as a mouse 1142. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1104 through an input device interface 1144 that can be coupled to the system bus 1108, but can be connected by other interfaces, such as a parallel port, an IEEE 1194 serial port, a game port, a USB port, an IR interface, a BLUETOOTH® interface, etc.

A monitor 1146 or other type of display device can be also connected to the system bus 1108 via an interface, such as a video adapter 1148. In addition to the monitor 1146, a computer typically includes other peripheral output devices (not shown), such as speakers, printers, etc.

The computer 1102 can operate in a networked environment using logical connections via wired and/or wireless communications to one or more remote computers, such as a remote computer(s) 1150. The remote computer(s) 1150 can be a workstation, a server computer, a router, a personal computer, portable computer, microprocessor-based entertainment appliance, a peer device or other common network node, and typically includes many or all of the elements described relative to the computer 1102, although, for purposes of brevity, only a memory/storage device 1152 is illustrated. The logical connections depicted include wired/wireless connectivity to a local area network (LAN) 1154 and/or larger networks, e.g., a wide area network (WAN) 1156. Such LAN and WAN networking environments are commonplace in offices and companies, and facilitate enterprise-wide computer networks, such as intranets, all of which can connect to a global communications network, e.g., the Internet.

When used in a LAN networking environment, the computer 1102 can be connected to the local network 1154 through a wired and/or wireless communication network interface or adapter 1158. The adapter 1158 can facilitate wired or wireless communication to the LAN 1154, which can also include a wireless access point (AP) disposed thereon for communicating with the adapter 1158 in a wireless mode.

When used in a WAN networking environment, the computer 1102 can include a modem 1160 or can be connected to a communications server on the WAN 1156 via other means for establishing communications over the WAN 1156, such as by way of the Internet. The modem 1160, which can be internal or external and a wired or wireless device, can be connected to the system bus 1108 via the input device interface 1144. In a networked environment, program modules depicted relative to the computer 1102 or portions thereof, can be stored in the remote memory/storage device 1152. It will be appreciated that the network connections shown are examples and other means of establishing a communications link between the computers can be used.

When used in either a LAN or WAN networking environment, the computer 1102 can access cloud storage systems or other network-based storage systems in addition to, or in place of, external storage devices 1116 as described above. Generally, a connection between the computer 1102 and a cloud storage system can be established over a LAN 1154 or WAN 1156 e.g., by the adapter 1158 or modem 1160, respectively. Upon connecting the computer 1102 to an associated cloud storage system, the external storage interface 1126 can, with the aid of the adapter 1158 and/or modem 1160, manage storage provided by the cloud storage system as it would other types of external storage. For instance, the external storage interface 1126 can be configured to provide access to cloud storage sources as if those sources were physically connected to the computer 1102.

The computer 1102 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

The above description of illustrated embodiments of the subject disclosure, comprising what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit, a digital signal processor, a field programmable gate array, a programmable logic controller, a complex programmable logic device, a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units.

As used in this application, the terms “component,” “system,” “platform,” “layer,” “selector,” “interface,” and the like are intended to refer to a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or a firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances.

While the embodiments are susceptible to various modifications and alternative

constructions, certain illustrated implementations thereof are shown in the drawings and have been described above in detail. It should be understood, however, that there is no intention to limit the various embodiments to the specific forms disclosed, but on the contrary, the intention is to cover all modifications, alternative constructions, and equivalents falling within the spirit and scope.

In addition to the various implementations described herein, it is to be understood that other similar implementations can be used or modifications and additions can be made to the described implementation(s) for performing the same or equivalent function of the corresponding implementation(s) without deviating therefrom. Still further, multiple processing chips or multiple devices can share the performance of one or more functions described herein, and similarly, storage can be effected across a plurality of devices. Accordingly, the various embodiments are not to be limited to any single implementation, but rather are to be construed in breadth, spirit and scope in accordance with the appended claims.

What is claimed is:

1. A system, comprising:
at least one processor; and
at least one memory that stores executable instructions that, when executed by the at least one processor, facilitate performance of operations, the operations comprising:
obtaining timeseries datasets based on cloud platform resource usage history representative of historical usage of resources of a cloud platform, the timeseries datasets comprising cluster-level resource consumption data for nodes of a cluster, namespace-level resource consumption data for namespaces in the cluster, and service container resource consumption data for service containers in the cluster; and
performing multivariate timeseries forecasting based on the timeseries datasets, comprising:
inputting the timeseries datasets into a graph learning layer that learns a graph adjacency matrix representative of a graph structure of graph nodes that models hidden relationships in the timeseries datasets,
applying graph convolution to the graph adjacency matrix to generate graph convolution output data based on the spatial dependencies in the graph nodes, and
applying temporal convolution to the graph convolution output data to extract high-level temporal features, representative of namespace-level forecast data for prediction of namespace resource consumption.

2. The system of claim 1, wherein the namespace-level resource consumption data is maintained in an absolute scale, and wherein the operations further comprise normalizing the namespace resource consumption history to a percentage scale.

3. The system of claim 1, wherein the service container resource consumption data is maintained in an absolute scale, and wherein the operations further comprise normalizing the service container resource consumption data to a percentage scale.

4. The system of claim 1, wherein the service container resource consumption data is representative of service containers of one or more pods of a containerized application deployment, scaling, and management system.

5. The system of claim 1, wherein the cluster-level resource consumption data comprises at least one of: central processing unit (CPU) usage data representative of CPU usage by the cluster, memory usage data representative of memory usage by the cluster, or storage device usage data representative of storage device usage by the cluster.

6. The system of claim 1, wherein the graph learning layer comprises a graph neural network.

7. The system of claim 1, wherein the graph learning layer learns the graph adjacency matrix based on sampling operations.

8. The system of claim 7, wherein the sampling operations determine pair-wise relationships among a subset of the graph nodes.

9. The system of claim 1, wherein the applying of the graph convolution comprises using a graph convolution module that comprises mix-hop propagation layers that process inflow and outflow information passed through each graph node separately.

10. The system of claim 1, wherein the high-level temporal features are further representative of cluster-level forecast data for prediction of cluster resource consumption.

11. The system of claim 10, wherein the namespace-level forecast data is represented according to an absolute scale, and wherein the cluster-level forecast data is represented according to a percentage scale.

12. The system of claim 1, wherein the applying of the temporal convolution comprises applying a set of one or more convolution filters.

13. A method, comprising:
obtaining, by a system comprising at least one processor, timeseries datasets representative of computing platform resource usage history, wherein the timeseries datasets comprise cluster-level resource consumption data for nodes of a cluster, namespace-level resource consumption data for namespaces in the cluster, and service container resource consumption data for service containers in the cluster;
normalizing, by the system, the namespace-level resource consumption data from an absolute scale to a percentage scale to obtain normalized timeseries datasets;
inputting the normalized timeseries datasets into a graph neural network that learns a graph adjacency matrix representative of a graph structure of graph nodes that models hidden relationships in the normalized timeseries datasets;
applying graph convolution to the graph adjacency matrix to generate graph convolution output data based on the spatial dependencies in the graph nodes; and
applying temporal convolution to the graph convolution output data to extract temporal features, representative of namespace-level forecast data usable to predict namespace resource consumption.

14. The method of claim 13, wherein the graph neural network learns the graph adjacency matrix based on sampling operations that determine pair-wise relationships among a subset of the graph nodes, and wherein the applying of the temporal convolution further extracts the temporal features representative of cluster-level forecast data usable to predict cluster resource consumption.

15. The method of claim 13, wherein the obtaining of the timeseries datasets comprises obtaining the service container resource consumption data for service containers of one or more pods of an automated system for deployment, scaling, and management of containerized applications.

16. The method of claim 13, wherein the computing platform resource usage history comprises at least one of: historical central processing unit (CPU) usage data, historical memory usage data, or historical storage device usage data.

17. The method of claim 13, further comprising, facilitating, by the system based on the graph structure, an association between a detected hidden variable to human-recognizable terminology corresponding to at least one of: an event, factor, or process.

18. A non-transitory machine-readable medium, comprising executable instructions that, when executed by at least one processor, facilitate performance of operations, the operations comprising:
forecasting future per-namespace resource usage in a service container orchestration system, in which service containers run in cluster nodes of a cluster, and in which logical namespaces span multiple cluster nodes of the cluster, the forecasting comprising:
obtaining timeseries datasets based on resource usage history data of the service container orchestration system, the timeseries datasets comprising cluster-level resource consumption data for the nodes of the cluster, namespace-level resource consumption data for the logical namespaces in the cluster, and service container resource consumption data for the service containers in the cluster;
normalizing the timeseries datasets to obtain normalized timeseries datasets; and
performing multivariate timeseries forecasting based on the normalized timeseries datasets, comprising:
inputting the normalized timeseries datasets into a graph neural network that learns a graph adjacency matrix representative of a graph structure of graph nodes that models at least one of hidden temporal relationships or hidden spatial relationships in the normalized timeseries datasets,
applying graph convolution to the graph adjacency matrix to generate graph convolution output data, and
applying temporal convolution to the graph convolution output data to extract temporal features, representative of the future per-namespace resource usage.

19. The non-transitory machine-readable medium of claim 18, wherein the applying of the temporal convolution further extracts the temporal features representative of cluster-level forecast data for predicting future cluster resource consumption.

20. The non-transitory machine-readable medium of claim 18, wherein the service container orchestration system comprises a Kubernetes® system in which the service containers are executed in one or more Kubernetes® pods.
